(19) United States
(12) Patent Application Publication
(10) Pub. No.: US 2026/0044863 A1
(43) Pub. Date: Feb. 12, 2026

(54) SYNERGIZING FRAGMENTED DATA

(71) Applicant: T-Mobile USA, Inc., Bellevue, WA (US)

(72) Inventors: Ugandhar DASI, Alpharetta, GA (US); Abhishekh NEERATY, Austin, TX (US); Chaitanya TALAVATA LAXMINARAYANA, Round Rock, TX (US)

(21) Appl. No.: 18/799,982

(22) Filed: Aug. 9, 2024

(51) Int. Cl. G06Q 30/016; G06Q 30/0204

(52) U.S. Cl. CPC G06Q 30/016; G06Q 30/0204

(57) ABSTRACT

Solutions are disclosed that synergize fragmented data for use by business enterprise operations. Examples use a master data management (MDM) platform to tag business enterprise data, such as customer relations management (CRM), billing, and enterprise resource planning (ERP) data with unique entity identifiers (IDs) and generate multi-domain master records. A customer data platform (CDP) is built that includes customer data products such as customer disconnection, lead scoring, and market segmentation. A data services layer has artificial intelligence (AI), generative AI, and an API layer, that permit efficient and accurate generation of next best action (NBA) and predictive analytics solutions, as well as access to the customer data products by a business-to-business (B2B) website server that leverages the data from the plurality of customer data products to improve B2B customer experience.

### BACKGROUND

Large business enterprise organizations (such as telecommunications companies, or “telcos”) need to manage fragmented customer assets and data scattered across multiple systems—often in widely-disparate, vendor-specific (proprietary) formats. This fragmentation results in prolonged resolution times for customer issues, extended call durations, and challenges in executing timely next best actions. Additionally, the fragmentation of business-to-business (B2B) customers'data may lead to inconsistencies, redundancies, and inaccuracies. This fragmented data landscape adversely impacts customer experience, decision-making, operational efficiency, and compliance efforts.

Next best action (NBA, also known as best next action, next best activity or recommended action), is a customer-centric approach to business decision-making that considers the different actions that can be taken for a specific customer and decides on the “best” one. The NBA solution for a customer is determined by that customer's interests and needs on one hand, and the organization's business objectives and policies on the other. Generating an NBA solution often involves the use of artificial intelligence (AI) or machine learning (ML), which are used synonymously herein. Unfortunately, however, fragmented business enterprise data renders the generation of NBA solutions inefficient when the AI (or ML) models attempt to access the disparate data formats.

### SUMMARY

The following summary is provided to illustrate examples disclosed herein, but is not meant to limit all examples to any particular configuration or sequence of operations.

Solutions are disclosed that synergize fragmented data, such as business enterprise data. Examples tag business enterprise data with a selected entity identifier (ID) of a plurality of unique entity IDs; generate, for each entity ID, a master record using the tagged business enterprise data; generate, for each entity ID, a plurality of customer data products using the master records and transactional data of the business enterprise data, the plurality of customer data products including at least two of: customer disconnection, lead scoring, and market segmentation; and generate a next best action (NBA) solution using the plurality of customer data products passed through a generative artificial intelligence (AI) model or accessed through an API layer.

### BRIEF DESCRIPTION OF THE DRAWINGS

The disclosed examples are described below with reference to the accompanying drawing figures listed below, wherein:

FIG. 1 illustrates an exemplary architecture that advantageously synergizes fragmented data for use by business enterprise operations;

FIG. 2 illustrates further detail for the master data management (MDM) platform of the architecture of FIG. 1;

FIG. 3 illustrates further detail for the customer data platform (CDP) of the architecture of FIG. 1;

FIG. 4 illustrates further detail for the data services layer of the architecture of FIG. 1;

FIGS. 5 and 6 illustrate flowcharts of exemplary operations associated with the architecture of FIG. 1; and FIG. 7 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that synergize fragmented data for use by business enterprise operations. Examples use a master data management (MDM) platform to tag business enterprise data, such as customer relations management (CRM), billing, and enterprise resource planning (ERP) data with unique entity identifiers (IDs) and generate multi-domain master records. A customer data platform (CDP) is built that includes customer data products such as customer disconnection, lead scoring, and market segmentation. A data services layer has artificial intelligence (AI), generative AI, and an API layer, that permit efficient and accurate generation of next best action (NBA) and predictive analytics solutions, as well as access to the customer data products by a business-to-business (B2B) website server that leverages the data from the plurality of customer data products to improve B2B customer experience.

Aspects of the disclosure improve the efficiency and accuracy of data mining of fragmented business enterprise data that arrives in widely-disparate vendor-specific (often proprietary) formats. This is accomplished, at least in part, by generating a master record using tagged business enterprise data, and generating a plurality of customer data products, for each entity ID, using the master records and transactional data of the business enterprise data.

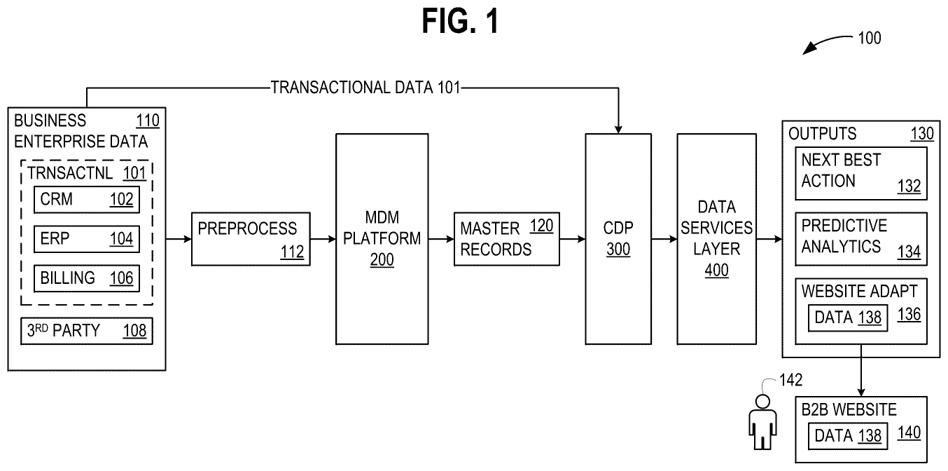

With reference now to the figures, FIG. 1 illustrates an exemplary architecture 100 that advantageously synergizes fragmented data for use by business enterprise operations (e.g., by a cellular network operator in the example of FIG. 1). The organization collects business enterprise data 110 from multiple sources, and in (often proprietary) vendor specific formats. Business enterprise data 110 has transactional data 101, which includes CRM data 102 for B2B customers, billing data 104 for B2B customers, and enterprise resource planning (ERP) data 106. In some examples, business enterprise data 110 also includes third party data 108 that is relevant to B2B customers, such as from vendor or otherwise (e.g., Dun & Bradstreet, video teleconferencing services, etc.)

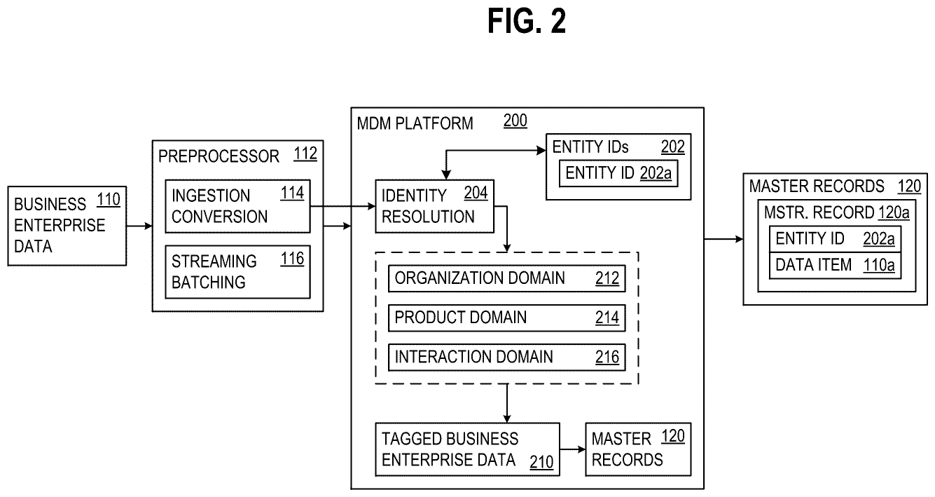

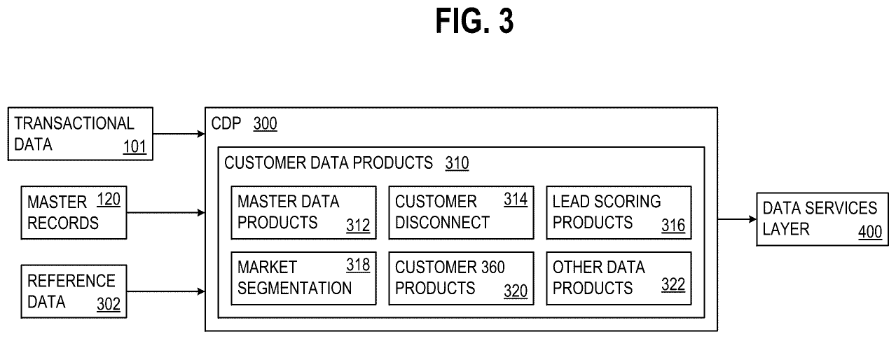

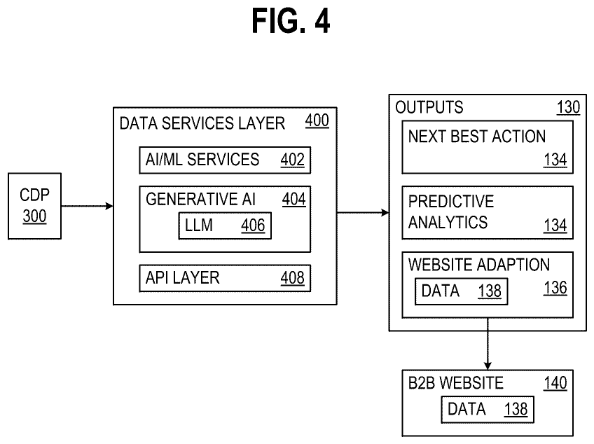

A preprocessor 112 preprocesses and performs data integration of business enterprise data 110 for an MDM platform 200, which produces a set of master records 120 for a CDP 300. Preprocessor 112, MDM platform 200, and master records 120 are shown in further detail in FIG. 2, and CDP 300 is shown in further detail in FIG. 3. A data services layer 400, which is shown in further detail in FIG. 4, provides a set of output products 130 for use by business enterprise operations (i.e., for leveraging by the cellular network operator or other business enterprise).

Output products 130 includes an NBA solution 132, a predictive analytics solution 134, and data 138 from a plurality of customer data products 310 (shown in FIG. 3) that is extracted and formatted by a website adaption component 136 to provide a B2B website server 140 the benefit of accessing plurality of customer data products 310 (i.e., data 138). Examples of uses by B2B website server 140 include account management tools for B2B customers (e.g., commercial customers) leveraging data 138. This improves the experience of a B2B customer 142 who is visiting a B2B website hosted by B2B website server 140. Data 138 may also be accessed by account management tools for general customers (including consumers), in some examples.

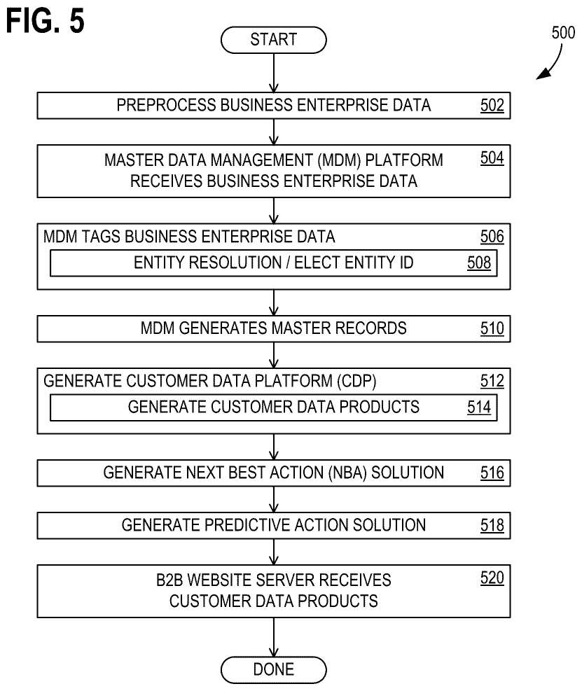

Further descriptions of the various components, along with descriptions of their operations and the operation of architecture 100 are provided in the following figures, such as FIGS. 2-4, and a flowchart of operations associated with architecture 100 in FIG. 5. Although FIG. 1 and some of the following figures are described using an example of a cellular network operator, it should be understood that the teachings herein are applicable to other types of business enterprises. To benefit from the teachings herein, another business enterprise, other than a cellular network operator, should receive business enterprise data in disparate formats, and perform data mining on that data, such as for NBA and predictive analytics purposes.

FIG. 2 illustrates further detail for preprocessor 112, MDM platform 200, and master records 120. Preprocessor 112 performs preprocessing and data integration of business enterprise data 110 for input into MDM platform 200. Preprocessor 112 has an ingestion function 114 that performs data and format conversion on business enterprise data 110 and outputs more consistent data to an identity resolution function 204 in MDM platform 200. Preprocessor 112 also has a streaming and batching function 116 that batches business enterprise data 110 for ingestion by multi-domain MDM functions in MDM platform 200 that include an organization domain 212, a product domain 214, and an interaction domain 216.

An organization domain includes commercial business entities, along with organizational hierarchies, such as information regarding subsidiaries and parent organizations. A product domain contains products (and product line hierarchies) being offered to customers, along with bundling strategies where applicable. An interaction domain holds presales, intra sales and post sales customer touchpoints, including both online and offline touchpoints.

Within MDM platform 200, identity resolution function 204 accesses a plurality of unique entity IDs 202 (such as one entity ID per customer), to select a particular entity ID for use in tagging each business enterprise data item. An example of a selected entity ID 202a is shown that is used to tag a particular business enterprise data item 110a (of business enterprise data 110), which appears within a representative master record 120a within master records 120.

The functions for organization domain 212, product domain 214, and interaction domain 216 each ingests raw business enterprise data 110, such as in batches provided by streaming and batching function 116, performs a match and merge on each data item, and uses the entity IDs selected by identity resolution function 204 to tag and assign data items to a particular master record in master records 120. These actions place tagged business enterprise data 210 in to master records 120.

FIG. 3 illustrates further detail for CDP 300. CDP 300 intakes transactional data 101 of business enterprise data 110, master records 120 from MDM platform 200, and reference data 302, to produce a plurality of customer data products 310. In some examples, plurality of customer data products 310 includes master data products 312, customer disconnection products 314, lead scoring products 316, market segmentation products 318, “customer 360” products 320, and other data products 322. Reference data 320 includes non-transactional information, such as product types, account types, market segments, channel types that do not change rapidly.

Master data products are generated by consolidating, organizing, and maintaining customer information from various sources, into a single, consistent data set. This may be leveraged to improve decision-making, customer experience, and operational efficiency.

Predicting customer propensity to disconnect (i.e., customer disconnect), also referred to as churn prediction, involves using data analytics and machine learning (ML) techniques to identify customers who are likely to stop using a product or service. Lead Scoring products are predictive AI/ML based prioritization of leads that are used for customer outreach. Market Segmentation is the grouping of customers by common needs or similarities in behaviors (or another criteria). Customer 360 data products provide comprehensive (360-degree) view of customer touchpoints from billing, products, services, usage, and other engagement.

FIG. 4 illustrates further detail for data services layer 400. In some examples, data services layer 400 has AI/ML services 402 that works with a generative AI model 404 to generate NBA solution 132 and predictive analytics solution 134. In some examples, generative AI model 404 has a large language model (LLM) 406, or more than one LLM. LLM 406 may be a commercially available LLM or a custom LLM. In some examples, external NBA generation functions and predictive analytics functions access plurality of customer data products 310 via an API layer 408, and generate NBA solution 132 and predictive analytics solution 134 externally to data services layer 400. API layer 408 also enables website adaption component 136 to access data 138, to provide data 138 to B2B website server 140.

FIG. 5 illustrates a flowchart 500 of exemplary operations associated with examples of architecture 100. In some examples, at least a portion of flowchart 500 may be performed using one or more computing devices 700 of FIG. 7. Flowchart 500 commences with preprocessing business enterprise data 110 for input into MDM platform 200, in operation 502, such as by performing batching and/or format conversion. In some examples, business enterprise data 110 comprises at least two of: CRM data 102 (for B2B customers), billing data 104 (for B2B customers), and ERP data 106, and third party data 108. CRM data 102, billing data 104, and ERP data 106 are each examples of transactional data 101.

MDM platform 200 receives business enterprise data 110 in operation 504, and in operation 506, MDM platform 200 tags business enterprise data 110 (each data item suitable for tagging) with a selected entity ID (e.g., entity ID 202a) of plurality of unique entity IDs 202. Operation 506 is performed using entity resolution in operation 508, which selects an entity ID for a business enterprise data item, such entity ID 202a for business enterprise data item 110a.

In operation 510, MDM platform 200 generates a master record (e.g., master record 120a) for each entity ID selected, using tagged business enterprise data 210. Some examples use both tagged business enterprise data 210 and untagged business enterprise data 110. In some examples, master records 120 are multi-domain records spanning at least two domains of: organization domain 212, product domain 214, and interaction domain 216.

Operation 512 generates CDP 300 using operation 514, which generates plurality of customer data products 310 for each entity ID, using master records 120 and transactional data 101 (and, in some examples, also reference data 302). Plurality of customer data products 310 includes at least two of: customer disconnection products 314, lead scoring products 316, and market segmentation products 318.

NBA solution 132 is generated in operation 516 using plurality of customer data products 310 passed through generative AI model 404 or accessed through API layer 408.

Predictive analytics solution 134 is generated in operation 518 using plurality of customer data products 310 passed through generative AI model 404 or accessed through API layer 408. In some examples, generative AI model 404 and API layer 408 are within data services layer 400, and generative AI model 404 has LLM 406. In operation 520, B2B website server 140 receives data 138 from plurality of customer data products 310, accessed through API layer 408.

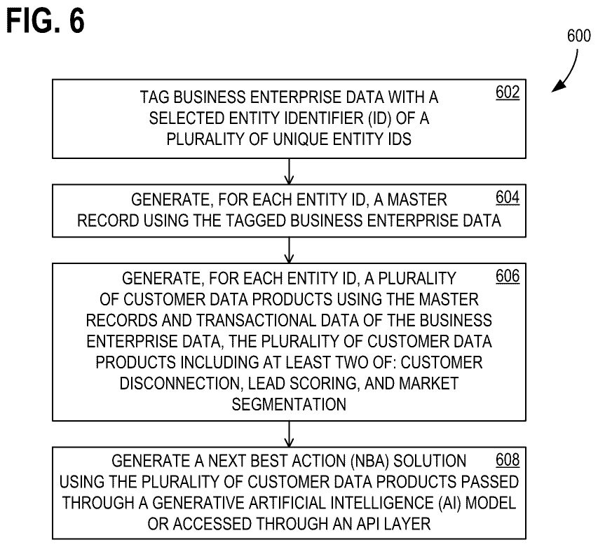

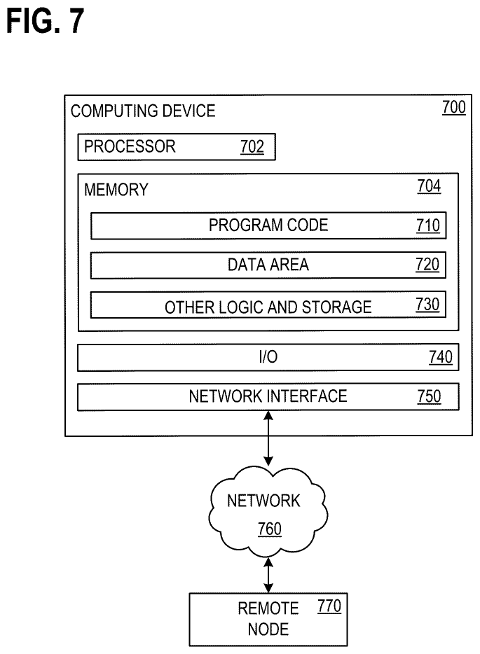

FIG. 6 illustrates a flowchart 600 of exemplary operations associated with architecture 100. In some examples, at least a portion of flowchart 600 may be performed using one or more computing devices 700 of FIG. 7. Flowchart 600 commences with operation 602, which includes tagging business enterprise data with a selected entity ID of a plurality of unique entity IDs.

Operation 604 includes generating, for each entity ID, a master record using the tagged business enterprise data. Operation 606 includes generating, for each entity ID, a plurality of customer data products using the master records and transactional data of the business enterprise data, the plurality of customer data products including at least two of: customer disconnection, lead scoring, and market segmentation. Operation 608 includes generating an NBA solution using the plurality of customer data products passed through a generative AI model or accessed through an API layer.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external network 760 with a remote node 770, which may represent another implementation of computing device 700. For example, a remote node 770 may represent another of the above-noted nodes within architecture 100.

### Additional Examples

An example system comprises: a processor; and a computer-readable medium storing instructions that are operative upon execution by the processor to: tag business enterprise data with a selected entity ID of a plurality of unique entity IDs; generate, for each entity ID, a master record using the tagged business enterprise data; generate, for each entity ID, a plurality of customer data products using the master records and transactional data of the business enterprise data, the plurality of customer data products including at least two of: customer disconnection, lead scoring, and market segmentation; and generate an NBA solution using the plurality of customer data products passed through a generative AI model or accessed through an API layer.

An example method comprises: tagging business enterprise data with a selected entity ID of a plurality of unique entity IDs; generating, for each entity ID, a master record using the tagged business enterprise data; generating, for each entity ID, a plurality of customer data products using the master records and transactional data of the business enterprise data, the plurality of customer data products including at least two of: customer disconnection, lead scoring, and market segmentation; and generating an NBA solution using the plurality of customer data products passed through a generative AI model or accessed through an API layer.

One or more example computer storage devices has computer-executable instructions stored thereon, which, upon execution by a computer, cause the computer to perform operations comprising: tagging business enterprise data with a selected entity ID of a plurality of unique entity IDs; generating, for each entity ID, a master record using the tagged business enterprise data; generating, for each entity ID, a plurality of customer data products using the master records and transactional data of the business enterprise data, the plurality of customer data products including at least two of: customer disconnection, lead scoring, and market segmentation; and generating an NBA solution using the plurality of customer data products passed through a generative AI model or accessed through an API layer.

Alternatively, or in addition to the other examples described herein, examples include any combination of the following:
receiving the business enterprise data into an MDM platform;
the MDM platform tags the business enterprise data with the entity IDs;
the MDM platform generates the master record;
generating the plurality of customer data products comprises generating a CDP;
a data services layer comprises the generative AI model and the API layer; and
the generative AI model comprises an LLM;
preprocessing the business enterprise data for input into the MDM platform;
the preprocessing comprises batching and/or format conversion;
the business enterprise data comprises at least two data types selected from the list consisting of: CRM data for B2B customers, third party data regarding the B2B customers, billing data for the B2B customers, and ERP data;
the transactional data of the business enterprise data comprises CRM data, billing data, and ERP data;
the master records are multi-domain records spanning at least two domains selected from the list consisting of: an organization domain, a product domain, and an interaction domain;
receiving, by a B2B website server, data from the plurality of customer data products, accessed through the API layer;
generating a predictive analytics solution using the plurality of customer data products passed through the generative AI model or accessed through the API layer;
selecting an entity ID for a business enterprise data item;
selecting the entity ID comprises entity resolution;
the business enterprise data comprises transactional data;
generating the master record using the tagged business enterprise data and untagged business enterprise data; and
generating the plurality of customer data products using the master records, transactional data of the business enterprise data, and reference data.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

1. A method comprising:
mining, from multiple systems, transactional data corresponding to business-to-business (B2B) customers of a cellular network operator, the transactional data including customer relationship management (CRM) data and billing data fragmented across the multiple systems;
tagging the transactional data with entity identifiers (IDs) of the B2B customers to identify which portion(s) of the transactional data are associated each of the corresponding B2B customers, the tagged transactional data being stored in master records of a master data management (MDM) platform;
generating customer data products based on the tagged transactional data stored in the master records of the MDM platform, the customer data products including customer disconnection products indicating propensities of the B2B customers to disconnect from a service provided by the cellular network operator and market segmentation products grouping the B2B customers based on common needs or similarities in behavior;
generating output data, including a next best action (NBA) solution, by passing at least one of the customer data products through a generative artificial intelligence (AI) model, wherein the output data is accessed through an API by a B2B website that provides account management tools for the B2B customers.

2. (canceled)

3. The method of claim 1, further comprising:
preprocessing the transactional data for input into the MDM platform, wherein the preprocessing comprises batching and/or format conversion.

4. (canceled)

5. The method of claim 1, wherein the master records are multi-domain records spanning at least two domains selected from the list consisting of: an organization domain, a product domain, and an interaction domain.

6.-7. (canceled)

8. A system comprising:
a processor; and
a computer-readable medium storing programming instructions for execution by the processor, the programming instructions, upon execution by the processor, causing the system to perform the following operations:
mining, from multiple systems, transactional data corresponding to business-to-business (B2B) customers of a cellular network operator, the transactional data including customer relationship management (CRM) data and billing data fragmented across the multiple systems;
tagging the transactional data with entity identifiers (IDs) of the B2B customers to identify which portion(s) of the transactional data are associated each of the corresponding B2B customers, the tagged transactional data being stored in master records of a master data management (MDM) platform;
generating customer data products based on the tagged transactional data stored in the master records of the MDM platform, the customer data products including customer disconnection products indicating propensities of the B2B customers to disconnect from a service provided by the cellular network operator and market segmentation products grouping the B2B customers based on common needs or similarities in behavior; and
generating output data, including a next best action (NBA) solution, by passing at least one of the customer data products through a generative artificial intelligence (AI) model, wherein the output data is accessed through an API by a B2B website that provides account management tools for the B2B customers.

9. (canceled)

10. The system of claim 8, wherein the programming instructions further cause the system to perform the following operation:
preprocessing the transactional data for input into the MDM platform, wherein the preprocessing comprises batching and/or format conversion.

11. (canceled)

12. The system of claim 8, wherein the master records are multi-domain records spanning at least two domains selected from the list consisting of: an organization domain, a product domain, and an interaction domain.

13.-14. (canceled)

15. One or more computer storage devices storing programming instructions for execution by a processor of a system, the programming instructions, upon execution by the processor, causing the system to perform the following operations:
mining, from multiple systems, transactional data corresponding to business-to-business (B2B) customers of a cellular network operator, the transactional data including customer relationship management (CRM) data and billing data fragmented across the multiple systems;
tagging the transactional data with entity identifiers (IDs) of the B2B customers to identify which portion(s) of the transactional data are associated each of the corresponding B2B customers, the tagged transactional data being stored in master records of a master data management (MDM) platform;
generating customer data products based on the tagged transactional data stored in the master records of the MDM platform, the customer data products including customer disconnection products indicating propensities of the B2B customers to disconnect from a service provided by the cellular network operator and market segmentation products grouping the B2B customers based on common needs or similarities in behavior; and
generating output data, including a next best action (NBA) solution, by passing at least one of the customer data products through a generative artificial intelligence (AI) model, wherein the output data is accessed through an API by a B2B website that provides account management tools for the B2B customers.

16. (canceled)

17. The one or more computer storage devices of claim 15, wherein the programming instructions further cause the system to perform the following operation:
preprocessing the transactional data for input into the MDM platform, wherein the preprocessing comprises batching and/or format conversion.

18. (canceled)

19. The one or more computer storage devices of claim 15, wherein the master records are multi-domain records spanning at least two domains selected from the list consisting of: an organization domain, a product domain, and an interaction domain.

20. (canceled)

21. The one or more computer storage devices of claim 15, wherein the generative AI model comprises a large language model (LLM).

22. The one or more computer storage devices of claim 15, wherein the transactional data further includes third party data regarding the B2B customers.

23. The one or more computer storage devices of claim 15, wherein the transactional data further includes enterprise resource planning (ERP) data.

24. The system of claim 8, wherein the generative AI model comprises a large language model (LLM).

25. The system of claim 8, wherein the transactional data further includes third party data regarding the B2B customers.

26. The system of claim 8, wherein the transactional data further includes enterprise resource planning (ERP) data.

27. The method of claim 1, wherein the generative AI model comprises a large language model (LLM).

28. The method of claim 1, wherein the transactional data further includes third party data regarding the B2B customers.

29. The method of claim 1, wherein the transactional data further includes enterprise resource planning (ERP) data.
